(19) United States
(12) Patent Application Publication
(10) Pub. No.: US 2004/0246102 A1
(43) Pub. Date: Dec. 9, 2004

(54) Method for improving the performance of an rfid transponder

(76) Inventors: Olli Jaakkola, Helsinki (FI); Timo Varpula, Vantaa (FI)

Correspondence Address: BIRCH STEWART KOLASCH & BIRCH, PO BOX 747, FALLS CHURCH, VA, 22040-0747, US

(21) Appl. No.: 10/491,533

(22) PCT Filed: Oct. 4, 2002
(86) PCT No.: PCT/FI02/00781

(30) Foreign Application Priority Data
Oct. 4, 2001 (FI) 20011943

(51) Int. Cl. H04Q 5/22

(52) U.S. Cl. 340/10.4; 340/10.1

(57) ABSTRACT

The present publication discloses a method for implementing a remote identification device (RFID). According to the method, a reader device sends a modulated carrier to a remote identification device or a remote sensor (20). According to the invention, a reply signal synchronized with the modulation of the carrier signal received by the remote identification device or remote sensor (20) is generated using the energy of the incident carrier signal.

The invention relates to a method according to the preamble of claim 1 for improving the performance of an RFID transponder system.

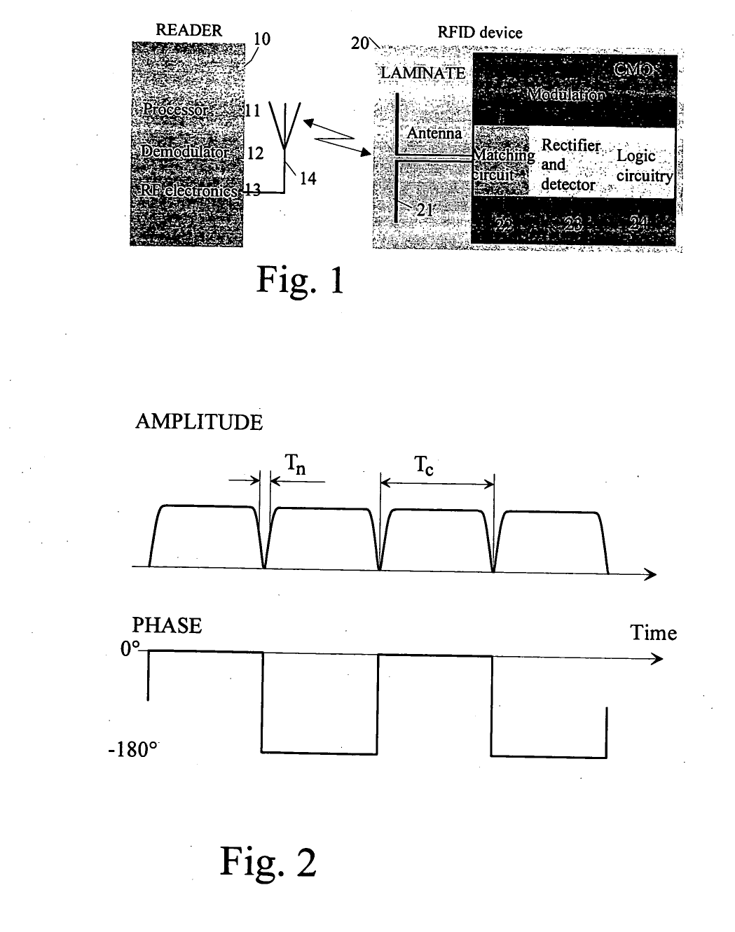

Generally, a remote identification device (such as an RFID transponder) is a miniature tag device comprising an antenna connected to a microcircuit with a memory that can respond by sending the contents of its memory by backscatter communications responsive to an interrogation signal received from an interrogating reader device when the transponder of the tag device is scanned by an RF signal emitted by the reader (refer to FIG. 1). A passive RFID transponder has no battery, but instead it captures its operating power from the radio-frequency field of the interrogation signal sent toward its direction by the reader device. Energy and information transfer between the remote identification device and the reader device may take place using a magnetic field, an electric field or an emitted radio-frequency signal. In many applications of the remote identification device technology, it is important that the distance from the reader device to the transponder can be made long—preferably up to several meters. For this purpose, it is essential to keep the power consumption of the remote identification device circuitry as low as possible.

Inasmuch as the RFID transponder is responsive to the incident interrogation signal of the reader device by backscattering the RF signal emitted by the reader device, the response signal of the remote identification device is very weak. Hence, it is essential to achieve a maximally high signal-to-noise ratio and immunity to spurious signals in the communication between the remote identification device and the reader.

Authority regulations on maximum permissible signal power levels and frequencies form the crucial confines of remote identification technology. In Europe, for instance, it is allowable to emit signals at a power level of 0.5 W (ERP) within a frequency band of 869.4-869.65 MHz. The communications may take place using a signal bandwidth of max. 250 kHz at 10% duty rate. As a passive remote identification device must generate its operating voltages and power from the incident RF signal received from the reader device, the remote identification device is operative only at the instant the reader sends the interrogating RF signal. Therefore, the frequency and power intensity of the radio-frequency signal sent by the reader device must be carefully optimized in order to assure reliable function of the remote identification device.

High signal-to-noise ratio and immunity to spurious signals in signal transmission between the reader device and the remote identification device can be attained by using a synchronous communications technique. A prerequisite for synchronous information transfer is that the clocks of the system are synchronized with each other. These kinds of remote identification device systems are already known in the art. When operating at 13.56 MHz frequency band, the remote identification device may directly derive its clock signal by division from the carrier signal frequency. This arrangement, however, requires that the remote identification device chip includes high-speed logic circuits that are power-hungry. Resultingly, the maximum read distance remains short.

It is an object of the present invention to provide an entirely novel type of method and system capable of overcoming the above-described problems of the prior art.

The goal of the invention is achieved by way of using a reader device that sends the remote identification device a radio-frequency signal whose modulation is used to generate a clock signal in in the remote identification device. Advantageously, the phase and amplitude of the radio-frequency signal emitted in the system is modulated so that the power level of the emitted signal level is kept almost continuous and its spectrum limited to the allocated bandwidth, whereby the remote identification device is adapted to generate its time reference signal from the modulation information of the incident signal. In practice, the modulation of the carrier is such that the carrier signal amplitude is at its maximum permissible level, but at certain intervals the amplitude is reduced, whereby also the phase of the carrier signal is reversed by about 180°. The invention is also suited for use in a remote sensor based on the remote identification technology. The invention is equally well suited for use remote identification device or remote sensor systems based on communication by a magnetic field, an electric field or an emitted radio-frequency signal.

More specifically, the method according to the invention is characterized by what is stated in the characterizing part of claim 1.

The invention offers significant benefits.

By virtue of the invention, a remote identification system can be improved in plural ways: the remote identification device becomes simpler and its power consumption is reduced inasmuch as it can operate with no clock at all or, alternatively, the clock circuit of the device may be optimized for minimal power consumption hence also being less accurate, since the clock synchronization takes place at the reception of the interrogation signal sent by the reader device. As both the reader and the remote identification device are thus synchronized to the same clock, their mutual signal transmission occurs in a synchronized fashion. The benefit gained by synchronous information transmission is a substantially improved signal-to-noise ratio over that of asynchronous transmission. Furthermore, synchronous transmission is also essentially more immune to spurious RF signals emitted by external sources. This is a crucial advantage in the case that plural reader devices, for instance, are used simultaneously at a close distance from each other for interrogating remote identification devices. By virtue of the almost continuous transmission power of the interrogation signal, the system offers long read distances.

Remote identification devices will in many cases replace such identification techniques as optically scanned barcode labels, for instance. This is because remote identification devices offer many benefits such as easy rewrite of their memory content, no need for a visual contact to the remote identification device being interrogated by means of an RF signal, a read distance of several meters and more.

In the following, the invention will be examined in greater detail with the help of exemplifying embodiments illustrated in the appended drawings in which

FIG. 1 is an illustrative diagram of a system suited for implementing the invention;

FIG. 2 is a graph illustrating the modulation of the signal emitted by the reader device in time plane;

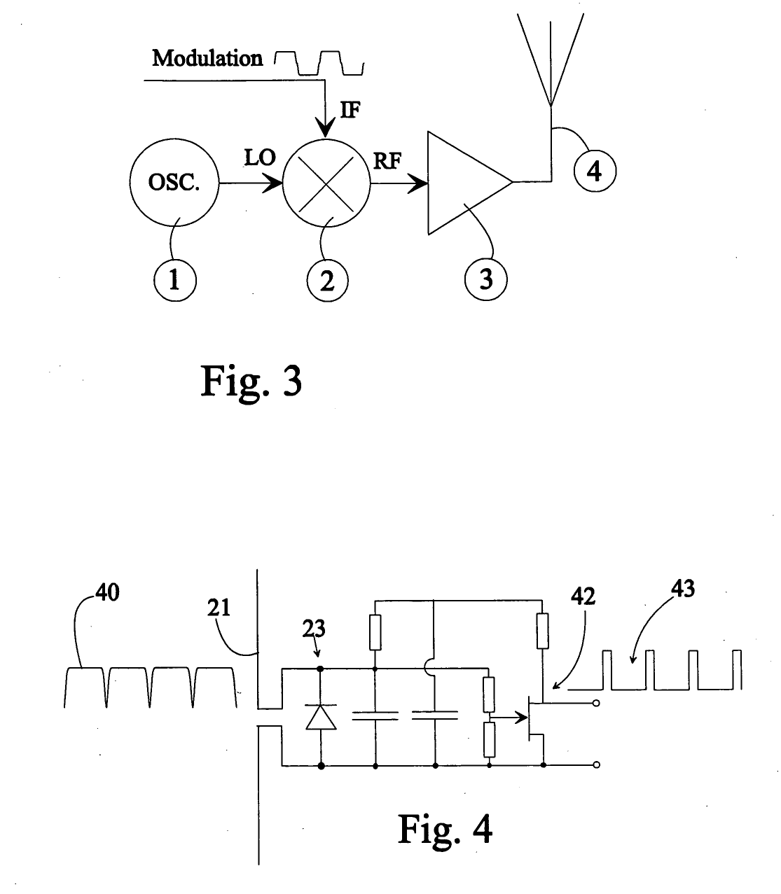

FIG. 3 is a functional block diagram of a transmitter according to the invention; and

FIG. 4 is a diagram of an exemplary embodiment of a circuit according to the invention suited for generating clock pulses in a remote identification device from the modulated carrier signal of the reader device.

Referring to FIG. 1, a typical remote identification system shown therein comprises a reader device 10 and a remote identification device 20 arranged to communicate wirelessly with each other. Generally, reader device 10 includes a processor 11, a demodulator 12 and RF circuitry 13 with an antenna 14 for generating an RF signal and receiving the same. The remote identification device 20 respectively comprises an antenna 21, a matching circuit 22, a rectifier and detector circuit 23 and a logic circuit 24. The modulated signal is processed jointly by logic circuit 24 and matching circuit 22. The remote identification device 20 is typically constructed on a thin, laminated substrate, generally in a credit card size.

The output signal S(t) of a reader device according to the invention when a maximally wide modulation frequency that still remains within an allocated bandwidth B is represented in time plane by equation:

S(t)=A cos(2πf_{rf}t)cos(2πfₘt),

where A is the signal amplitude, f_{rf} is the carrier frequency and fₘ is the modulation frequency. The maximum of the modulation frequency is f_{m,max}=B/2.

In FIG. 2 is shown the time relationship between the RF signal amplitude and phase when the modulation frequency is lower than B/2. The remote identification device generates its clock reference signal from either the amplitude or the phase modulation. As can be seen in the time-plane diagram, transmitted power level can be kept at the maximum permitted by authority regulations, with the exception of short low-power periods. The lower the modulation frequency the longer are the full-power periods. Then, the average power level approaches the maximum permitted value. A key feature of the invention is that the modulation signal shown in FIG. 2 is shaped such that the frequency and power level of the modulated carrier optimally utilize the allocated frequency band (e.g., 869.4-869.65 MHz). In practice the carrier is modulated so that the carrier amplitude is kept at maximum permissible power level, while at given intervals the carrier amplitude is reduced and the carrier phase is reversed by about 180°.

In FIG. 3 is shown the construction of a reader device comprising a transmitter formed by an oscillator 1, a mixer 2, an output amplifier 3 and an antenna 4 for signal transmission. The modulation frequency is mixed with the oscillator signal in mixer 2, whereby an RF signal is obtained for feeding the antenna.

In FIG. 4 is shown an exemplary embodiment of circuitry suited for rectifying and detecting in rectifier 23 the interrogation signal received by the remote identification device antenna 21. Leaving the rectifier/detector, the detected signal still contains the envelope shape of the received interrogation signal 40 as an AC component wherefrom the clock reference signal can be extracted by circuit 42. Thus, the signal taken to the transistor base is converted into clock signal 43.

In addition to remote identification devices, the above-described technique may also be employed in other remote identification components such as remote sensors.

In the context of this application, the term “reader” is used when reference is made to any device that can communicate with the remote identification device. Accordingly, typical reader devices are bus pass readers, tracking readers of supply chains, road tolling readers or, e.g., personal ID card readers.

What is claimed is:

1. A method for implementing a remote identification system, the method comprising the step of
sending with help of a reader device (10) a modulated carrier to a remote identification device or a remote sensor (20), and
the identification device or a remote sensor (20) is adapted to generate a clock signal synchronized with the modulation of the received carrier and a reply signal using the energy of the incident carrier signal,
characterized in that
the carrier signal is modulated in a fashion keeping the carrier signal amplitude at its maximum permissible level, but at certain intervals reducing the amplitude whereby also the phase of the carrier signal is reversed by about 180°.

2. The method of claim 1, characterized in that said modulation is accomplished by multiplying the carrier by a modulator such that the carrier amplitude is reduced at given intervals, whereby also the carrier phase is reversed by about 180°.

3. The method of claim 1 or 2, characterized in that said modulation is accomplished by means of a product mixer (2) or the like, wherein the carrier amplitude is reduced at given intervals, whereby also the carrier phase is reversed by about 180°.
